(19) United States
(12) Patent Application Publication
(10) Pub. No.: US 2026/0038736 A1
(43) Pub. Date: Feb. 5, 2026

(54) ELECTRICAL OPERATING MEANS COMPRISING A TAP CHANGER

(71) Applicant: Maschinenfabrik Reinhausen GmbH, Regensburg (DE)

(72) Inventors: Laurenc Kirchner, Regensburg (DE); Sebastian Rehkopf, Regensburg (DE); Karsten Viereck, Regensburg (DE)

(21) Appl. No.: 18/997,102

(22) PCT Filed: Jul. 5, 2023
(86) PCT No.: PCT/EP2023/068579

§ 371 Date: Jan. 20, 2025

(30) Foreign Application Priority Data
Jul. 21, 2022 (DE) 10 2022 118 217.7

(51) Int. Cl. H01F 29/02; H01H 9/00; H01H 9/54

(52) U.S. Cl. CPC H01F 29/025; H01H 9/0027; H01H 9/541

(57) ABSTRACT

An item of electrical equipment comprises at least one tap winding having winding taps and at least one partial winding, and a tap changer for changing a transmission ratio, an impedance or a voltage, used for excitation of the item of electrical equipment. The tap changer comprises a first module for connecting the winding taps of the at least one winding tap to one another and a second module for rapid switching-in, switching-out or bypassing of the at least one partial winding. The second module comprises at least one submodule having semiconductor switching elements, and a bypass switch.

### CROSS REFERENCE TO RELATED APPLICATIONS

This application is a U.S. National Phase application under 35 U.S.C. § 371 of International Application No. PCT/EP2023/068579, filed on Jul. 5, 2023, and claims benefit to German Patent Application No. DE 10 2022 118 217.7, filed on Jul. 21, 2022. The International Application was published in German on Jan. 25, 2024 as WO 2024/017645 Al under PCT Article 21(2).

### FIELD

The invention relates to an item of electrical equipment comprising at least one tap winding having winding taps, at least one partial winding and a tap changer for changing a transmission ratio, an impedance or a voltage, used for excitation, of the item of electrical equipment.

### BACKGROUND

When regulating energy supply networks, a distinction is made between two different time ranges. In what is known as the steady-state range, suitable equipment is used to set a static operating point in an energy supply network, which enables reliable operation of the network with low fluctuations in load and infeed. The regulation is carried out here in the time range of one minute. In the dynamic range, suitable equipment is used to react to dynamic fluctuations in the network, which may be caused for example by faults or rapid and possibly only temporary changes in the infeed and load situation. In this case, very fast regulation in the range of milliseconds is necessary in order to keep the network stable.

Since the demand for reactive power also changes alongside the respective infeed and load situation, reactive power regulation is an essential component of reliable, efficient and minimal-loss network management.

Suitable equipment is already known from the prior art both for network regulation in the steady-state range and for dynamic voltage regulation. By way of example, regulated transformers, phase shifters or regulated shunt reactors are thus used to regulate static network operation. Static synchronous compensators (STATCOM) or static reactive power compensators (SVC) are used to carry out regulation in the event of dynamic network behavior, for example.

In particular, equipment used to carry out regulation in the dynamic range will become increasingly relevant in the foreseeable future for reliable network management on account of the energy revolution and the integration of decentralized energy generation into network operation, since the infeed achieved through renewable energies is less predictable.

In addition to regulating energy supply networks, the different time ranges mentioned above also play an essential role in the energy supply of electric arc furnaces. Appropriate furnace transformers for supplying power to electric arc furnaces generally contain tap changers that make it possible to regulate the power of the furnace transformer in the range of a few seconds to minutes. However, due to rapidly changing operating conditions in electric arc furnaces, such as for example the breaking of the arcs used for melting, undesirable network perturbations, such as for example flicker, with time constants in the millisecond range, often also occur in electric arc furnaces. To limit these network perturbations, use is made of compensation installations (SVC), which are usually likewise complex and expensive.

A further field of application in which the abovementioned time ranges play a role is electrolysis installations for hydrogen production, in which rectifier transformers regulated by means of tap changers are used. The possibility of regulating in the dynamic time range is in particular relevant for participation in the balancing energy market in order to be able to provide the grid with positive or negative balancing energy as quickly as possible.

An item of equipment that makes it possible to carry out regulation both in the steady-state range or the second-to-minute range and in the dynamic or millisecond range in combination has not yet to date been disclosed in the prior art.

### SUMMARY

In an embodiment, the present disclosure provides an item of electrical equipment. The electrical equipment comprises at least one tap winding having winding taps and at least one partial winding, and a tap changer for changing a transmission ratio, an impedance or a voltage, used for excitation, of the item of electrical equipment. The tap changer comprises a first module for connecting the winding taps of the at least one winding tap to one another and a second module for rapid switching-in, switching-out or bypassing of the at least one partial winding. The second module comprises at least one submodule having semiconductor switching elements, and a bypass switch.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of a first embodiment of an item of electrical equipment according to an embodiment of the present invention;

FIG. 2 shows a schematic illustration of a second embodiment of the item of electrical equipment according to an embodiment of the present invention;

FIG. 3 shows a schematic illustration of a third embodiment of the item of electrical equipment according to an embodiment of the present invention; and

FIG. 4 shows one preferred embodiment of a method according to an embodiment of the present invention.

### DETAILED DESCRIPTION

In accordance with an embodiment, the present invention provides methods and systems for regulating energy supply networks or energy supply installations that provides a combined, flexible regulation solution for serving both time ranges, and which is also inexpensive, space-saving and exhibits low losses during operation and in production.

Embodiments of the present invention are based on the idea of combining a conventional tap changer, as is sufficiently known from the prior art, with a power-electronics tap changer located in series therewith. Since the power-electronics tap changer is able to change its switching position quickly, namely in the millisecond range, and in the process adopt any position, this makes it possible to adapt the voltage quickly to rapidly changing load and infeed conditions. The conventional tap changer is used to serve the steady-state range, covering the widest possible regulating range. This makes it possible to achieve a high degree of flexibility in terms of network management and also installation and process management.

According to the embodiments of the present invention, an item of electrical equipment is specified which comprises at least one main winding, at least one tap winding having winding taps, at least one partial winding and a tap changer for changing a transmission ratio, an impedance or a voltage, used for excitation, of the item of electrical equipment.

The item of electrical equipment may be in the form of a regulated transformer, a phase-shifting transformer, a regulated reactor or a regulated transformer having a capacitor.

According to one embodiment, the item of electrical equipment is in the form of a regulated transformer and the tap changer is designed to change the transmission ratio of the regulated transformer.

According to one embodiment, the item of electrical equipment is in the form of a regulated reactor and the tap changer is designed to change the impedance of the regulated reactor.

According to a further embodiment, the item of electrical equipment comprises a first inductive arrangement and a second inductive arrangement. The actual voltage in the first inductive arrangement is used to excite the second inductive arrangement, and the power output of the first inductive arrangement is thereby increased. In other words, according to this embodiment, an excitation transformer, a first inductive arrangement, is supplemented by a booster transformer, a second inductive arrangement. The voltage, used for exciting the booster transformer, is changed by means of the tap changer. The arrangement makes it possible to set the operating parameters of the tap changer, current and voltage, more flexibly, in particular in the case of high-power units.

According to a further embodiment, the item of electrical equipment is in the form of a phase-shifting transformer. Phase-shifting transformers are special power transformers which can influence the phase angle of the voltage or the electrical load flow over an overhead line in a targeted manner by introducing a quadrature voltage or a phase-shifted voltage. According to this embodiment, the phase-shifting transformer comprises a series transformer and an excitation transformer. The tap changer is designed to set a determined phase shift by changing the transmission ratio of the excitation transformer.

The tap changer comprises a first module for connecting the winding taps of the tap winding to one another and a second module having semiconductor switching elements for the rapid switching-in, switching-out or bypassing of the at least one partial winding. The second module comprises at least one submodule having semiconductor switching elements, and a bypass switch.

According to one embodiment, the at least one partial winding is at least as large as a proportion of the tap winding between two adjacent winding taps of the tap winding. In other words, the at least one partial winding has a certain number of turns which is at least as many as the smallest number of turns present between two adjacent winding taps of the tap winding. In the event that the item of electrical equipment has multiple partial windings, then the numbers of turns of the multiple partial windings may be integer multiples of one another.

According to one embodiment, the first module is in the form of an on-load tap changer, in particular a fast resistor-type tap changer, for uninterrupted changeover between different winding taps of the tap winding of the item of electrical equipment and has a selector for the powerless preselection of that winding tap of the item of electrical equipment to which a changeover is to be performed, and a diverter switch for carrying out the actual, uninterrupted changeover from the previously connected winding tap to the new, preselected winding tap. For the powerless preselection of the winding taps, the selector generally has two movable selector contacts that connect the winding taps to one another. The diverter switch usually has switching contacts and resistors for the actual diverter switch operation. The switching contacts are for example in the form of vacuum interrupters. The resistors are used to limit the circulating current that flows briefly in the diverter switch during the changeover process and are also referred to as transition resistors.

According to a further embodiment, the first module is in the form of a reactor-type tap changer. According to the reactor-type tap changing principle, the circulating current is limited by reactors.

According to one embodiment, the item of electrical equipment has multiple partial windings and the second module has multiple submodules having semiconductor switching elements. Each submodule is assigned at least one partial winding, and each submodule is designed for the rapid switching-in, switching-out or bypassing of the at least one assigned partial winding. Bypassing specifically means that the respective partial winding does not carry any current.

According to one embodiment, a submodule comprises for example four commutation cells which are in the form of a bridge circuit.

According to one embodiment, a commutation cell in each case comprises two thyristor paths connected in anti-parallel, it also being possible for a path to consist of multiple thyristors connected in series.

According to a further embodiment, the bypass switch is designed to bypass the second module having the at least one submodule having semiconductor switching elements.

According to one embodiment, the bypass switch is in the form of a circuit breaker or load disconnect switch.

According to a further embodiment, the tap changer is able to be actuated in a predefined operating mode in which the bypass switch is closed and the at least one submodule having semiconductor switching elements is bypassed.

According to a further embodiment, when the tap changer is in the predefined operating mode, only the first module is used for changing the transmission ratio, the impedance or the voltage, used for excitation, of the item of electrical equipment.

According to a further embodiment, when the tap changer is in the predefined operating mode, the second module adopts a neutral position in which the at least one partial winding is bridged. Bridged means kept at potential but not carrying a current. In other words, the semiconductor switching elements of the second module are interconnected with one another so as to form a bypass for the at least one partial winding.

The advantage of this embodiment is that the item of electrical equipment can be operated by the first module without interruption, while the bypass switch carries the continuous current and thus bridges the semiconductor switching elements. This may be required for example when the second module is serviced or there is a disruption caused by failure of the power supply for controlling the semiconductor switching elements. In addition, operating the tap changer in the predefined operating mode makes it possible to avoid losses through the semiconductor switching elements of the second module.

According to a further embodiment, the tap changer is operated in a predefined second operating mode in which the second module is used to change the transmission ratio, the impedance or the voltage used for excitation.

The advantage of this embodiment is that, when the tap changer is operated in the second operating mode, the mechanics and the electrically switching contacts of the first module are conserved and the life thereof is prolonged by virtue of less wear of the corresponding components.

According to one embodiment, the first module comprises a first control unit, the second module comprises a second control unit, and the item of electrical equipment comprises a system controller which is designed to actuate the first and the second control unit.

According to one embodiment, the second module and the first control unit and the second control unit and the system controller are each arranged in a separate housing.

According to one embodiment, the second module and the first control unit and the second control unit and the system controller are arranged in a common housing.

According to one embodiment, the second module and the second control unit are arranged in a common housing.

According to one embodiment, the second module and the first control unit are arranged in a common housing.

According to one embodiment, the second module and the second control unit and the system controller are arranged in a common housing.

According to one embodiment, the second module and the first control unit and the system controller are arranged in a common housing.

According to one embodiment, the second module and the first control unit and the second control unit are arranged in a common housing.

According to one embodiment, the first control unit and the second control unit are arranged in a common housing.

According to one embodiment, the first control unit and the second control unit and the system controller are arranged in a common housing.

According to one embodiment, the second module is arranged in a housing of the item of electrical equipment.

According to a further embodiment, the bypass switch is arranged in a separate housing or is arranged in a common housing with the second module.

According to a further embodiment, the first control unit comprises a motor-drive unit. The motor-drive unit is preferably designed to actuate the selector contacts and the switching contacts of the on-load tap changer to connect the winding taps of the tap winding to one another. The motor-drive unit can be in the form of a direct drive without interposed gears.

By way of example, the second control unit is in the form of a microcontroller.

According to one embodiment, the second control unit is designed to actuate the at least one or the multiple submodules or their assigned commutation cells suitably such that the at least one or the multiple partial windings are quickly switched into or switched out of the tap winding or are bypassed.

The invention is explained below in detail on the basis of exemplary embodiments with reference to the drawings. Components which are identical or functionally identical or which have an identical effect may be provided with identical reference signs. Identical components or components with an identical function are in some cases explained only in relation to the figure in which they first appear. The explanation is not necessarily repeated in the subsequent figures.

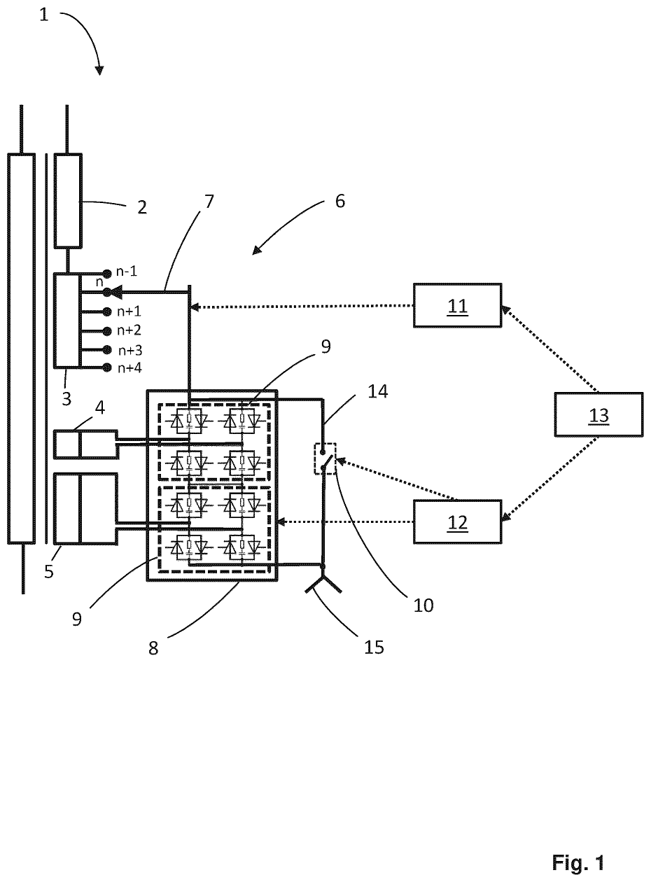

FIG. 1 shows a schematic illustration of a first embodiment of an item of electrical equipment 1 according to an embodiment of the present invention.

By way of example, the item of electrical equipment 1 is in the form of a single-phase regulated transformer here. The regulated transformer 1, on the primary or secondary side, has a main winding 2, a tap winding 3 having n winding taps, and two partial windings 4 and 5. The partial winding 5 has a greater number of turns than the partial winding 4, for example a number of turns three times higher. Moreover, the number of turns of the partial winding 4, and therefore also that of the partial winding 5, is greater than the smallest number of turns present between two adjacent winding taps, for example between n and n+1, of the tap winding 3.

The number of partial windings is not restricted to two. In principle, provision may also be made for multiple partial windings whose number of turns may each be an integer multiple of the partial winding 4.

The transformer 1 furthermore has a tap changer 6 for changing the transmission ratio of the transformer 1. The tap changer 6 comprises a first module 7 for connecting the winding taps n, n+1 of the tap winding 3 to one another and a second module 8, connected in series with the first module 7, for the switching-in, switching-out or bypassing of the partial windings 4, 5. The first module 7 is intended to carry out regulation in the steady-state range, and the second module 8 is intended to carry out regulation in the dynamic time range.

The first module 7 is preferably in the form of an on-load tap changer consisting of a selector for the powerless preselection of the winding taps n, n+1 and a diverter switch for uninterrupted changeover from the previously connected winding tap n to the new, preselected winding tap n+1. The on-load tap changer may additionally have a preselector which may be in the form of a coarse tap connection or reversing changeover selector. However, for better clarity, the first module 7 is illustrated in a highly simplified manner in FIG. 1.

The second module 8 preferably has two submodules 9 each having four commutation cells in an H bridge circuit. A commutation cell has in each case a thyristor pair connected in anti-parallel here. Each submodule 9 is assigned a respective partial winding 4 or 5 and each submodule 9 is designed, by way of the commutation cells or semiconductor switching elements, to switch the respective partial winding 4 or 5 into or out of the tap winding 3 quickly, that is to say within 10 to 1000 milliseconds, or to bypass the respective partial winding 4 or 5 such that the partial winding 4, 5 has a certain potential but does not carry a current.

The second module 8 furthermore has a bypass switch 10 which is arranged in a connecting line 14 parallel to the second module 8 and which is designed to bypass the second module 8 or the two submodules 9. The connecting line 14 leads to a load take-off lead 15.

The first module 7 comprises a first control unit 11 which is preferably in the form of a motor-drive unit, particularly preferably a direct drive without interposed gears, which actuates the selector and the diverter switch.

The second module 8 is controlled by a second control unit 12. The second control unit 12 is designed to actuate the two submodules 9 or their assigned commutation cells suitably such that the two partial windings 4 and 5 are quickly connected into or out of the tap winding 3, or are bypassed. Moreover, the second control unit 12 is designed to actuate the bypass switch 10.

The first control unit 11 and the second control unit 12 are actuated depending on one another by a system controller 13.

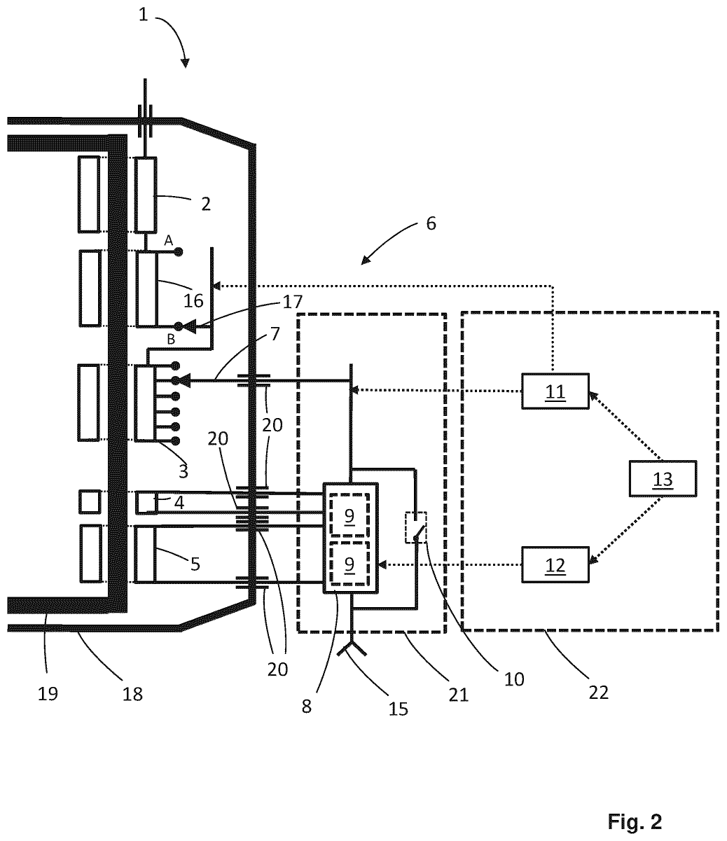

FIG. 2 illustrates a schematic illustration of a second embodiment of the item of electrical equipment according to an embodiment of the present invention. With regard to the item of electrical equipment 1 from FIG. 2, reference is analogously made to the above explanations with respect to the item of electrical equipment from FIG. 1, and only the differences and additions with respect to the item of electrical equipment 1 from FIG. 1 are discussed below.

FIG. 2 shows an item of electrical equipment 1 which is in the form of a regulated reactor. Such arrangements are used for reactive power regulation in the energy supply network. The regulated reactor 1, in addition to having a main winding 2, a tap winding 3 having n winding taps, and two partial windings 4 and 5, additionally has a coarse winding 16 and a coarse tap regulator 17. The coarse tap regulator 17 is able to adopt a first position, in which it makes contact with a first end A of the coarse winding 16, and a second position, in which it makes contact with a second end B of the coarse winding 16. If the coarse tap regulator 17 is in the first position, the coarse winding 16 does not carry a current. If on the other hand the coarse tap regulator 17 is in the second position, the coarse winding 16 carries a current and is consequently added to the main winding 2 and the tap winding 3. The regulating range of the reactor 1 is thereby increased.

The reactor 1 is housed in a tank 18 and has a core 19 on which the windings 2, 3, 16, 4, 5 are arranged. The on-load tap changer 7 is likewise arranged in this tank 18. The electrical lines of the on-load tap changer 7 and of the windings 2, 3, 16, 4, 5 are led out of the tank 18 via bushings 20. Outside the tank 18, flexible lines can for example be connected to the bushings 20, which flexible lines lead in turn to the second module 8 and/or to the control units 11, 12.

According to this exemplary embodiment, the second module 8, which is illustrated in a simplified manner here, and the bypass switch 10 are arranged together in a first housing 21, and the first control unit 11, the second control unit 12 and the system controller 13 are arranged together in a second housing 22. In this case, the housings 21 and 22 can be in the form of customary control cabinets or containers and are arranged directly on the tank 18 of the reactor 1 or of the item of electrical equipment or else in physical proximity thereto, for example inside the substation in which the item of electrical equipment 1 is located. It is likewise possible for the second module 8, the bypass switch 10, the control units 11 and 12 and the system controller 13 to be arranged in a common housing or else for separate housings to be provided for each of the individual units.

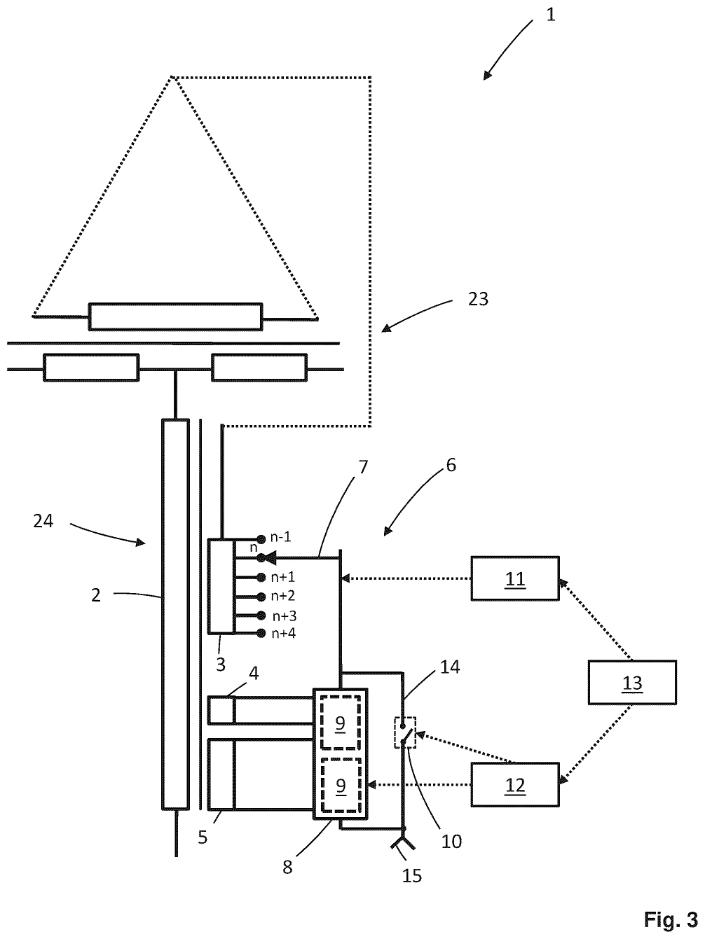

FIG. 3 shows a schematic illustration of a third embodiment of the item of electrical equipment according to an embodiment of the present invention. With regard to the item of electrical equipment 1 from FIG. 3, reference is analogously made to the above explanations with respect to the item of electrical equipment from FIGS. 1 and 2, and only the differences and additions with respect to the item of electrical equipment 1 from FIGS. 1 and 2 are discussed below.

FIG. 3 illustrates an item of electrical equipment 1 which is in the form of a phase-shifting transformer. For better clarity, the phase-shifting transformer 1 has by way of example a single-phase design here. The phase-shifting transformer 1 shown in FIG. 3 is in the form of a cross regulator for active power regulation and has a two-core design consisting of a series transformer 23 and an excitation transformer 24, which are arranged on a respective core. The excitation transformer 24 has a primary side having a main winding 2 and a secondary side comprising a tap winding 3 having n winding taps, and two partial windings 4 and 5 and an on-load tap changer 6. Via the excitation transformer 24, on the primary side thereof a voltage is decoupled and this is regulated according to magnitude as an additional voltage by means of the on-load tap changer 6 on the secondary side via the tap winding 3 and the two partial windings 4 and 5. This additional voltage produced in the excitation transformer 24 is delta-connected in the series transformer 23. The result of this is a phase shift of the additional voltage by 90 degrees with respect to the input voltage at the phase-shifting transformer.

The item of electrical equipment shown in FIG. 3 in the form of a phase-shifting transformer is not limited to the shown embodiment. The phase-shifting transformer can equally have a symmetrical or asymmetrical two-core design, have a single-core design having a tap winding in the star point, be in the form of a cross regulator or phase-angle regulator, or else be in the form of an autotransformer having two iron circuits and a grounded booster circuit.

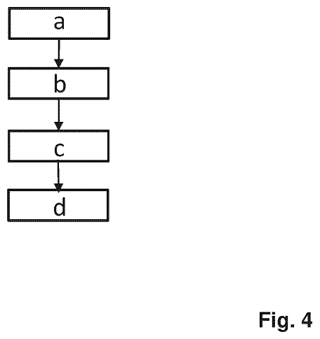

FIG. 4 shows a flowchart of one advantageous embodiment of a method according to an embodiment of the present invention, in particular a method for starting up an item of electrical equipment 1 according to one of the embodiments as have been explained in connection with FIGS. 1 to 3.

In the starting situation, a circuit breaker assigned to the item of electrical equipment 1 is open, that is to say the circuit between the item of electrical equipment and a corresponding energy network to which the item of electrical equipment is assigned is interrupted. In other words, the item of electrical equipment is separated from the associated energy network. The bypass switch 10 is equally in an open state.

In order to start up the item of electrical equipment, the bypass switch 10 is now closed in a step a. In a subsequent step b, the circuit breaker is closed and the item of electrical equipment 1 is thus connected to the energy network. Connecting the item of electrical equipment 1 to the network can result in increased inrush currents (so-called inrush effect). However, these flow via the closed bypass switch 10 of the second module 8 such that the submodules 9 having the semiconductor switching elements are not damaged thereby. From this point on, the second module is already ready for operation and can be used to change the transmission ratio, the impedance or the voltage, used for excitation, of the item of electrical equipment 1. In a subsequent step c, the second module 8 is commutated into the neutral position in which the partial windings 4 and 5 are bridged, that is to say do not carry current. In a subsequent step d, the bypass switch 10 is opened again. The second module 8 is now also ready for operation and can be used in addition to the first module 7 to change the transmission ratio, the impedance or the voltage, used for excitation, of the item of electrical equipment.

The combination of a conventional on-load tap changer, a first module, with a power-electronics tap changer, a second module, makes it possible to achieve a large regulating range while at the same time achieving an inexpensive and space-saving arrangement at high potential. This is because the second module, which is more cost-intensive compared to the first module, for rapid regulation in the dynamic regulating range is able to be designed in a manner optimized for the respective application. Consequently, the second module may accordingly be designed only for that part of the regulation for which the power-electronics-based second module offers an advantage due to its switching speed. In addition, the combined solution is significantly more space-saving than a purely power-electronics-based solution. In summary, the solution according to the invention makes it possible to achieve a high degree of flexibility with comparatively small space requirements for network management and furnace operation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

1 Item of electrical equipment
2 main winding
3 tap winding
4 first partial winding
5 second partial winding
6 tap changer
7 first module of 6
8 second module of 6
9 submodule of 8
10 bypass switch
11 first control unit
12 second control unit
13 system controller
14 connecting line
15 load take-off lead
16 coarse winding
17 coarse tap regulator
18 tank
19 core
20 bushing
21 first housing
22 second housing
23 series transformer
24 excitation transformer
A first end of 16
B second end of 16
n−1, n, . . . n+4 winding taps

1. An item of electrical equipment, comprising:
at least one tap winding having winding taps, and at least one partial winding,
a tap changer for changing a transmission ratio, an impedance or a voltage, used for excitation, of the item of electrical equipment,
wherein:
the tap changer comprises a first module for connecting the winding taps of the at least one tap winding to one another and a second module for rapid switching-in, switching-out or bypassing of the at least one partial winding,
the second module comprises at least one submodule having semiconductor switching elements, and a bypass switch.

2. The item of electrical equipment as claimed in claim 1, wherein
the at least one partial winding is at least as large as a proportion of the tap winding between two adjacent winding taps of the at least one tap winding.

3. The item of electrical equipment as claimed in claim 1, wherein
the bypass switch is designed to bypass the second module having the at least one submodule having semiconductor switching elements.

4. The item of electrical equipment as claimed in claim 1, wherein
the bypass switch is in the form of a circuit breaker or load disconnect switch.

5. The item of electrical equipment as claimed in claim 1, wherein
the tap changer is able to be-actuated in a predefined operating mode in which the bypass switch is closed and the at least one submodule having semiconductor switching elements is bypassed.

6. The item of electrical equipment as claimed in claim 5, wherein
when the tap changer is in the predefined operating mode,
only the first module is used for changing the transmission ratio, the impedance or the voltage, used for excitation; of the item of electrical equipment.

7. The item of electrical equipment as claimed in claim 1, wherein
the first module comprises a first control unit,
the second module comprises a second control unit, and
the item of electrical equipment comprises a system controller which is designed to actuate the first control unit and the second control unit.

8. The item of electrical equipment as claimed in claim 7, wherein
the second module and/or the first control unit and/or the second control unit and/or the system controller are each arranged in a separate housing or in a common housing.

9. The item of electrical equipment as claimed in claim 7, wherein
the first control unit comprises a motor-drive unit,
the motor-drive unit is in the form of a direct drive without interposed gears.

10. The item of electrical equipment as claimed in claim 1, wherein
the bypass switch is arranged in a separate housing or is arranged in a common housing with the second module.

11. The item of electrical equipment as claimed in claim 1, wherein
the first module is in the form of a fast resistor-type tap changer or of a reactor-type tap changer.
